(19) United States
(12) Patent Application Publication
(10) Pub. No.: US 2003/0139847 A1
(43) Pub. Date: Jul. 24, 2003

(54) Visually enhanced intelligent article tracking system

(75) Inventor: Yu-Hsuan Tsai, Hsin-chu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/060,494

(22) Filed: Jan. 29, 2002

(51) Int. Cl. G06F 7/00

(52) U.S. Cl. 700/226

(57) ABSTRACT

A manufacturing process moves work in progress among various processing stations in a transportable container. The container has associated therewith an electronic data card that can store information about the work in progress. The data card further has a microcomputer and a set of instructions for performing conditional checks upon the stored information. The operator is alerted to critical information in accordance with the conditional checks by way of light emitting diodes.

### TECHNICAL FIELD

The present invention is generally related to microchip fabrication. More particularly, the invention relates to microchip fabrication process and equipment information and communication thereof.

### BACKGROUND OF THE INVENTION

Transportable containers for carrying, storing and processing wafer cassettes are commonly employed in microchip fabrication. Such containers are generally characterized by small, included volumes that provide for substantially contaminant free environment for wafers not subject to infusion of contaminants by way of uncontrolled gas exchanges. These containers are adapted for mechanically interfacing with processing equipment such that a canopy or secondary outer cover establishes an air lock or mini clean space at the interface between the container port and process equipment port. Port doors on the canopy and the container mate such that simultaneous opening thereof traps any particles there between. The cassette is mechanically transferred from the container to the cassette port of the process equipment. After processing, the cassette is returned to the container in a reverse fashion. It can be appreciated that these transfers occur without infiltration of outside contaminants.

Information corresponding to the wafers in a particular container is commonly stored in an electronic data card mounted to the container. Wafers in a particular container may be referred to herein as a production lot. The data card is adapted to store process and equipment data corresponding to the wafers within the associated container and the associated container itself. Furthermore, the data card may be adapted to interface electronically with each processing station when the container is engaged with the canopy of the processing station. Such interfacing provides for the two-way transfer of data between the data card and a local controller associated with the processing station. Typically, an optical interface including phototransmitters and photodetectors provide for the electronic interface and transfer of data. The local controller may be networked with other local control processors from other processing stations to a central controller as part of a computer integrated manufacturing process. A display associated with each local controller may display data read from the data card mounted to the container that is then currently engaged with the corresponding station.

The data card may itself include alphanumeric display means such as a liquid crystal display for the display of the information stored therein. Typically, data is stored and displayed in a certain number of rows of a certain number of characters, for example fourteen rows of sixteen characters each. An operator may request display of the information by pressing buttons located on the face of the data card. Limited display space on the display means requires toggling through lines of stored data to find the data of interest to the operator. This is the typical manner in which any data stored on the data cards is retrieved when containers are being stored in process queue between stations. It can be very labor intensive and time consuming for an operator to manually search through a plurality of containers within a certain batch or group, or between batches and groups, for particular information such as lot identification, part (final product) identification, processing priority, etc.

In a microchip fabrication operation there may be a number of different final products being produced simultaneously. Wafers corresponding to the same final product will be contained on a cassette and housed within a container. There may be groups of same product containers containing similar wafers being processed to yield the same final product. There may be batches of such same product containers containing wafers that are at substantially the same point in the fabrication process. Similarly, wafers corresponding to different final products will be contained on different cassettes and housed within different containers from other final product containers. These final product containers may similarly be kept in groups of same product containers. There may be batches of such same product containers containing wafers that are distinct from batches of other containers. It can be appreciated that station scheduling can be quite complex and is done so with objectives including efficient utilization of each processing station and timely completion of production runs.

Containers are transported between processing stations. Fabrication involves many complex and diverse processes requiring a significant number of different processing stations and transportation there between. Also, the diversity of processes and associated processing times commonly results in container storage for substantial periods of time between utilization at processing stations. Limited battery capacity of the data card necessitates operator requests to display the data and further necessitates automatic display disablement between such requests to prevent battery depletion during extended periods of storage.

### SUMMARY OF THE INVENTION

Therefore, it is one object of the present invention to provide container specific information to the operator when a container is not interfaced with a local processor. It is a further object of the present invention to provide such information in a manner that does not require operator intervention in the form of information requests.

It is a further object of the present invention to provide such information to the operator visually.

These and other objects of the invention will be clear from following description of a preferred embodiment wherein apparatus for visually conveying information in a manufacturing process comprises a container for transporting work in progress used in the manufacturing process. An electronic data card follows the container through at least a portion of the manufacturing process. The data card includes a microcomputer and stores data related to the manufacturing process and related equipment. At least one light emitter is associated with the electronic data card and is operable in response to a set of instructions executed by the microcomputer to convey predetermined information about one or more of the manufacturing process and related equipment.

### BRIEF DESCRIPTION OF THE DRAWINGS

The present invention will now be described, by way of example, with reference to the accompanying drawings, in which:

FIG. 1 illustrates a schematic diagram of a microchip fabrication processing station including a container and associated data card as described further herein;

FIG. 2 is a diagram of a data card showing passive and active operator interface features in accordance with the present invention; and,

FIG. 3 is a schematic diagram of a visual indicator circuit in accordance with the present invention.

### DESCRIPTION OF THE PREFERRED EMBODIMENT

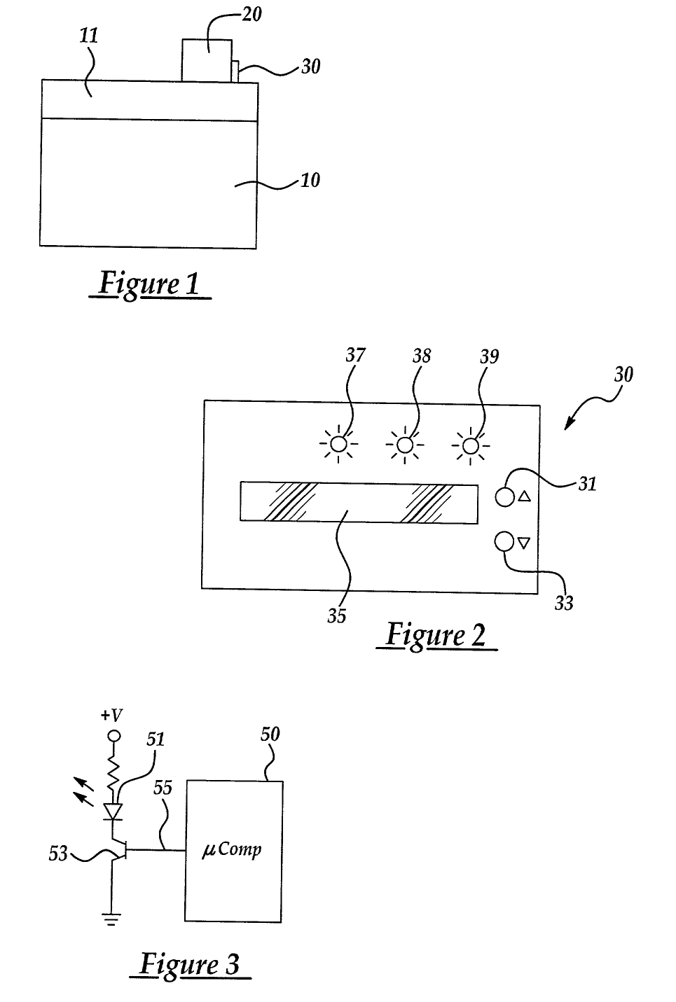

With reference first to FIG. 1 a processing station 10 is illustrated in schematic form. The processing station 10 includes a canopy 11. Mounted to the container 20 is data card 30 described in further detail below. In operation, a container 20 is engaged to the canopy 30 and the data card communicates by way of an electronic interface with a local controller (not shown). A variety of validations and checks are performed to ensure that the container and its contents (work in progress) are at the proper station before the port doors on the container and canopy open and the cassette housing the wafers is loaded into the processing station. Validations and checks are performed by referencing the data contained on the data card. Additionally, processing data contained on the data card may be utilized by the local controller in establishing process control parameters for use in processing the present cassette of wafers at the current processing station.

The data card 30 is further described with respect to FIG. 2. The outer case of the data card is illustrated as an exemplary embodiment according to the present invention as it would appear to an operator. The data card has a display 35 such as a liquid crystal display. Operator interface buttons 31 and 33 allow the operator to view, line by line, a plurality of stored data lines on display 35. For example, a single touch of either button 31 or 33 may cause the display to illuminate and display the first line entry of data stored on the data card for the operator to read. After a certain amount of time and without further operator depression of the buttons 31 or 33 the display will blank to conserve limited battery capacity. If the operator desired a line different from the one initially displayed, depression once of the button 33 would bring the next line of data into the display 35. The operator would continue to depress the button 33 to continue to toggle through the list of data contained on the data card 30 until the data required is brought into the display 35. Button 33 operates to toggle through the list from the top down. The other button 31 operates in the same fashion as button 33; however, it functions to toggle through the list of data in the opposite direction, i.e. from the bottom up.

The data card further includes a microcomputer 50 illustrated in FIG. 3. The microcomputer 50 includes such conventional circuit elements as a microprocessor, static and dynamic memory (e.g. ROM and RAM), and clock. The data card communicates with the local processor when the container to which it is mounted is engaged with the corresponding processing station canopy. The communication means may include pairs of optically coupled transmitters and receivers (not shown). The data card further includes a battery (not shown) to provide power to the circuitry at least during periods when the container is not engaged with a canopy. During periods when the container is engaged with the canopy, power may be supplied to the data card from the processing station. An exemplary data card is described in further detail in U.S. Pat. No. 5,166,884 assigned to Asyst Technologies Inc., the contents of which are hereby incorporated by reference.

With reference back to FIG. 2, visual indicators 37, 38, and 39 are shown as part of the data card visible to the operator. While three such indicators are illustrated, more or fewer indicators may be utilized in accordance with the desired application objectives. Preferably, the indicators are light emitting diodes (LED) which give off relatively bright light for a given energy consumption at low voltages and are suitable for use in conjunction with solid state electronics such as the presently described data card. The LED may be of the same color or may be different colors such as red, yellow, and green. The LED are commanded on or off by outputs from the microcomputer 50 in the data card. In FIG. 3, and exemplary schematic drive arrangement for a single LED 51 is shown. The drive arrangement includes an output line 55 from the microcomputer 51 coupled to a driver 53 such as a conventional low-side driver. The driver 53 couples the LED 51 to ground when a high logic signal appears on line 55 causing the LED 51 to illuminate.

The signal on a microcomputer output line and hence the on or off state of the LED corresponding thereto is established by a set of instructions executed by the microcomputer to perform one or more conditional check upon stored information corresponding to the manufacturing process or related equipment. For example, an LED may indicate a true or false state of a particular validation, check, or diagnostic performed upon data contained on data card 30. More particularly, a conditional check performed upon a stored variable is performed and the result conveyed visually and without intervention by the operator by the state of one or more LED.

For example, a data card may contain data corresponding to an assigned priority for processing such as high or low, or first, second and third, etc. Such data heretofore would be known to the operator only through depression of the buttons 31, 33 to find the desired line containing the data and searching the various available containers. The present invention can display such priority data in a number of ways. The instruction set executed by the microcomputer may command a single LED to illuminate continuously to convey high priority and not illuminate continuously to convey low priority. An intermediate priority may be conveyed by commanding the LED into a flashing state.

Using again the example of priority data, a three LED system wherein red, yellow and green LED are utilized to convey high, medium and low priorities, respectively, is also proposed. Here, only one of the three LED is illuminated at a time whereby the operator may discern simply from the color of the LED illuminated what the priority of the container is. Alternatively, single color LED may be employed and illumination position (e.g. right, center, left or top, center, bottom) of the illuminated LED used to convey the priority information to the operator. Likewise, intermediate priority data may be conveyed by multiple LED illumination such as green/yellow to convey a priority between the lowest and the middle, and yellow/red to convey a priority between the middle and the highest. In a binary coding scheme, each LED may also be used to represent a digit of an n-bit binary number allowing for 2ⁿ discrete states to be displayed visually where n also equals the number of LED, and the relative positions of the LED correspond to the significant digit positions of the binary number.

It is envisioned also that critical information to be conveyed to the operator visually by the present invention may be information that changes over time during a complete fabrication cycle or many fabrication cycles. For example, data corresponding to a container cleaning time may be contained on the data card. Such may be measured by a date certain, expiration of an internal timer, or number of port door cycles as non-exhaustive examples. Continuous illumination of a single LED may convey a request to clean the container in response to the time to clean criteria having been met. A warning of an approaching time to clean may be conveyed by flashing the LED. The significance of a constantly illuminated and flashing LED may also be reversed. It can be appreciated that quick visual indication to the operator of imminent or immediate need for container cleaning may reduce the instance of low yields due to overdue cleaning. Other data indicative of a time/cycle event may be similarly conveyed, including other requests for preventive maintenance. Multiple LED may be employed as previously described with respect to the example of conveying priority information. That is, multiple colors may be employed with single colors and combinations of colors signifying relative priority, or in the present example relative time until a particular event or procedure is required or recommended. Alternatively, the binary coding scheme may also be employed. A single LED may be controllably illuminated to convey critical information about a single piece of information, or multiple LED may be controllably illuminated to convey critical information about a single piece of information. Multiple LED may be controllably illuminated to convey critical information about multiple pieces of information.

Another specific example of the utility of such a system is with respect to the limited battery capacity of the data card. Battery capacity or battery life may be measured such as with a simple timer expiration or via a more sophisticated methodology used to determine the battery state of charge. Such state of charge determination techniques are known and may require additional circuitry such as voltage and current comparators and A/D circuitry.

The invention has been described with respect to certain preferred embodiments to be taken by way of example and not by way of limitation. Certain alternative implementations and modifications may be apparent to one exercising ordinary skill in the art. Therefore, the scope of invention as disclosed herein is to be limited only with respect to the appended claims.

The invention in which an exclusive property or privilege is claimed are defined as follows:

What is claimed is:

1. Apparatus for visually conveying information in a manufacturing process comprising:
a container for transporting work in progress used in the manufacturing process;
an electronic data card that follows the container through at least a portion of the manufacturing process, said electronic data card including a microcomputer and containing data related to one or more of the manufacturing process and related equipment; and,
at least one light emitter associated with the electronic data card and operable in response to a set of instructions executed by said microcomputer to convey predetermined information about one or more of the manufacturing process and related equipment.

2. The apparatus as claimed in claim 1 wherein said data is related to a predetermined time to clean said container.

3. The apparatus as claimed in claim 1 wherein said data is related to priority of the work in progress associated with said container.

4. The apparatus as claimed in claim 1 wherein the data card further includes a battery and said data is related to battery life.

5. The apparatus as claimed in claim 1 wherein said light emitter is a light emitting diode.

6. The apparatus as claimed in claim 1 wherein said work in progress comprises microchip wafers.

7. An electronic data card for storing predetermined manufacturing process and related equipment information, said electronic data card including a microcomputer, an alphanumeric display and operator interface buttons for operator retrieval of stored manufacturing process and related equipment information, the improvement comprising:
at least one light emitting diode conditionally illuminated in accordance with a set of instructions executed by the microcomputer to perform at least one conditional check upon at least one of said stored manufacturing process and related equipment information.

8. The electronic data card as claimed in claim 7 wherein said manufacturing process and related equipment information comprises a preventive maintenance variable.

9. The electronic data card as claimed in claim 7 wherein said manufacturing process and related equipment information comprises a process priority variable.

10. The electronic data card as claimed in claim 7 further comprising a battery, wherein said manufacturing process and related equipment information comprises a battery life variable.

11. A method of visually conveying critical information associated with a production lot of work in progress wafers in a microchip fabrication process comprising the steps:
providing an electronic data card capable of storing information, executing a set of instructions, and having at least one controllably illuminated LED;
associating said electronic data card with said production lot throughout at least a portion of the fabrication process;
storing predetermined information corresponding to the production lot on said data card;
providing the electronic data card with a set of executable instructions for performing conditional checks on said predetermined information; and,
controlling the illumination of said at least one LED in a predetermined manner in accordance with results of said conditional checks on said predetermined information, whereby the manner in which the LED is illuminated conveys critical information associated with said production lot related to said predetermined information.

12. The method as claimed in claim 11 wherein multiple LED are controllably illuminated to convey critical information related to a single piece of information.

13. The method as claimed in claim 11 wherein multiple LED are controllably illuminated to convey critical information related to multiple pieces of information.
